(19) United States
(12) Patent Application Publication
(10) Pub. No.: US 2020/0160258 A1
(43) Pub. Date: May 21, 2020

(54) AUTOMATICALLY BUILD A MANUFACTURING SUPPLY CHAIN FOR HANDLING A PRODUCTION WORK ORDER

(71) Applicant: Texas State University, San Marcos, TX (US)

(72) Inventor: Farhad Ameri, Austin, TX (US)

(21) Appl. No.: 16/678,937

(22) Filed: Nov. 8, 2019

Related U.S. Application Data
(60) Provisional application No. 62/768,739, filed on Nov. 16, 2018.

(51) Int. Cl. G06Q 10/08; G06Q 10/06; G06Q 10/10

(52) U.S. Cl. CPC G06Q 10/087; G06Q 10/10; G06Q 10/067

(57) ABSTRACT

A computer-implemented method, system and computer program product for automatically building a manufacturing supply chain. Digital models of manufacturing facilities for suppliers are built. Capability and capacity information are then received from the suppliers to be annotated with the digital models of the manufacturing facilities. Latent and implicit capability patterns are discovered using the received capability information from the suppliers. The manufacturing capabilities of manufacturing suppliers are then extracted from the digital models using the capability information provided by the suppliers and the discovered latent and implicit capability patterns. After receiving a production work order containing capabilities for servicing the production work order, capabilities for servicing the production work order are matched with manufacturing suppliers using the extracted manufacturing capabilities of the manufacturing suppliers. A manufacturing supply chain is then built including those manufacturing suppliers with matched capabilities for servicing the production work order.

### GOVERNMENT INTERESTS

This invention was made with U.S. Government support under Agreement No. W31P4Q-14-2-0001 for the Digital Manufacturing and Design Innovation Institute. The U.S. Government has certain rights in the invention.

### TECHNICAL FIELD

The present invention relates generally to supply chain selection, and more particularly to automatically building a manufacturing supply chain for handling a production work order.

### BACKGROUND

A supply chain is a system of organizations, people, activities, information, and resources involved in moving a product or service from the manufacturing supplier (or simply “supplier”) to the customer. Supply chain activities involve the transformation of natural resources, raw materials, and components into a finished product that is delivered to the end customer. In sophisticated supply chain systems, used products may re-enter the supply chain at any point where residual value is recyclable.

The manufacturing industry is undergoing profound changes brought about by the emergence of service-oriented, cloud-based, and digital manufacturing paradigms. The democratization of manufacturing is among the most visible trends that have reshaped the manufacturing landscape within the past few years. With a lowered barrier to entry, a larger number of small-to-medium sized enterprises (SMEs) are capable of offering diverse manufacturing services both internally and externally through building virtual supply networks and exploiting the resources provided by distributed partners. Consumers of manufacturing services can benefit from a larger and more diverse supply pool since they are provided with a wider range of options when searching for qualified suppliers. Nevertheless, the sheer size of the supply pool presents multiple challenges to efficiently evaluating and selecting manufacturing suppliers.

Traditional approaches to manufacturing capability evaluation and supplier selection often entail direct interaction with the supplier and possibly visiting the supplier's facility to obtain better insight into the technological and organizational capabilities of the supplier. Supplier visits, accompanied by pilot production runs, will result in accurate evaluation of suppliers' capabilities but this approach is not scalable when it comes to evaluating a large group of suppliers in an agile business environment. As the interaction between suppliers and customers becomes increasingly virtual and the lifespan of supply chains becomes shorter, more efficient and intelligent approaches to capability evaluation are needed. Virtual capability analysis can be conducted through web search, online surveys, or exploring the profiles of suppliers on e-sourcing portals but they only provide rudimentary information about suppliers' capabilities. This issue is compounded by the lack of structure and formality in the way both suppliers and e-sourcing portals represent and advertise manufacturing capabilities. There are no industry standard information models for capability representation and modeling. This is major gap that needs to be filled in the digital manufacturing ecosystem.

### SUMMARY

In one embodiment of the present invention, a computer-implemented method for automatically building a manufacturing supply chain comprises building digital models of manufacturing facilities for suppliers. The method further comprises receiving capability and capacity information from the suppliers to be annotated with the digital models of the manufacturing facilities. The method additionally comprises discovering latent and implicit capability patterns using the received capability information from the suppliers. Furthermore, the method comprises extracting manufacturing capabilities of manufacturing suppliers from the digital models of the manufacturing facilities using the capability information provided by the suppliers and the discovered latent and implicit capability patterns. Additionally, the method comprises receiving a production work order containing capabilities for servicing the production work order, where the capabilities in the production work order comprise one or more of the following: material capability, process capabilities and production volume. In addition, the method comprises matching capabilities for servicing the production work order with manufacturing suppliers using the extracted manufacturing capabilities of manufacturing suppliers. The method further comprises building a manufacturing supply chain comprising the manufacturing suppliers with matched capabilities for servicing the production work order.

Other forms of the embodiment of the computer-implemented method described above are in a system and in a computer program product.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE DRAWINGS

A better understanding of the present invention can be obtained when the following detailed description is considered in conjunction with the following drawings, in which:

FIG. 1 illustrates an embodiment of the present invention of a hardware configuration of a computing device which is representative of a hardware environment for practicing the present invention;

FIG. 2 is a flowchart of a method for automatically building a manufacturing supply chain to service a production work order in accordance with an embodiment of the present invention;

FIG. 3 illustrates that CaMDiF (Capability Modeling for Digital Factories) enables factory digitization and supply chain configuration in accordance with an embodiment of the present invention;

FIG. 4 illustrates that 3^{rd} party applications can use the capability models generated by the CaMDiF platform in accordance with an embodiment of the present invention;

FIG. 5 illustrates the software architecture of the CaMDiF framework in accordance with an embodiment of the present invention;

FIG. 6 illustrates the class diagram related to different types of capability for a production machine in accordance with an embodiment of the present invention;

FIG. 7 illustrates different types of production and manufacturing capabilities for a typical factory in accordance with an embodiment of the present invention;

FIG. 8 illustrates the components of an instance of an Okuma® vertical mill in accordance with an embodiment of the present invention;

FIG. 9 illustrates some of the physical qualities in Manufacturing Service Description Language (MSDL) in accordance with an embodiment of the present invention;

FIG. 10 illustrates some of the physical and temporal qualities of an instance of a tool changer system in accordance with an embodiment of the present invention;

FIG. 11 illustrates the class diagram for the surface roughness capability class in MSDL in accordance with an embodiment of the present invention;

FIG. 12 illustrates some of the MSDL continuants in accordance with an embodiment of the present invention; and

FIG. 13 illustrates the procedure for calculating the surface finish capability of a factory in accordance with an embodiment of the present invention.

### DETAILED DESCRIPTION

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

Embodiments of the present invention are directed to developing a framework for manufacturing capability representation and dissemination to enable agile supply chain formation. In one embodiment, a formal reference ontology for representation of manufacturing capabilities of contract manufacturing companies is developed. With a reference ontology, manufacturing suppliers can describe their manufacturing capabilities more accurately and comprehensively. Using a standardized terminology enhances information interoperability throughout the lifecycle of a supply chain. As a result, supply and demand entities can be matched to each other with more precision. Also, since the ontology uses machine-understandable semantics, the automation of supplier evaluation and supply chain formation processes can be realized more efficiently.

Original Equipment Manufacturers (OEMs) need more rigorous models and methods for evaluating prospective suppliers in terms of their technological capabilities. SMEs need to enhance their visibility through advertising their capabilities in an accurate and verifiable manner. However, the problem of capability representation is not addressed adequately in practice. Capability representation is often conducted in an ad hoc manner using informal and incomplete templates and vocabularies. There is not even a universally agreed-upon definition for manufacturing capability and its sub-types. It is necessary for the manufacturing industry in general, and the contract manufacturing industry in particular, to take a more systematic and holistic approach to representing and sharing manufacturing capabilities and skills. In one embodiment, the present invention uses open-source reference ontologies for unifying the semantics of this highly heterogeneous domain that can significantly reduce the deficiencies caused by proprietary and incompatible information models. In one embodiment, a community of users and developers may use the platform of the present invention in order to extend the ontology in a collaborative fashion, supported by the necessary governance mechanisms, and to promote the adoption of formal capability models in industry through demonstrating multiple use cases.

Embodiments of the present invention include a software tool that automatically builds a manufacturing supply chain for production of a given part. The software tool uses a repository of manufacturing suppliers. The repository provides rich descriptions of the manufacturing capabilities of the companies registered in the repository. In one embodiment, the software tool is based on Semantic Web (SW) technologies.

In various embodiments of the present invention, the software tool automatically infers implicit capabilities of manufacturing companies based on the explicitly stated capabilities. Furthermore, embodiments of the present invention compare different supply chain alternatives.

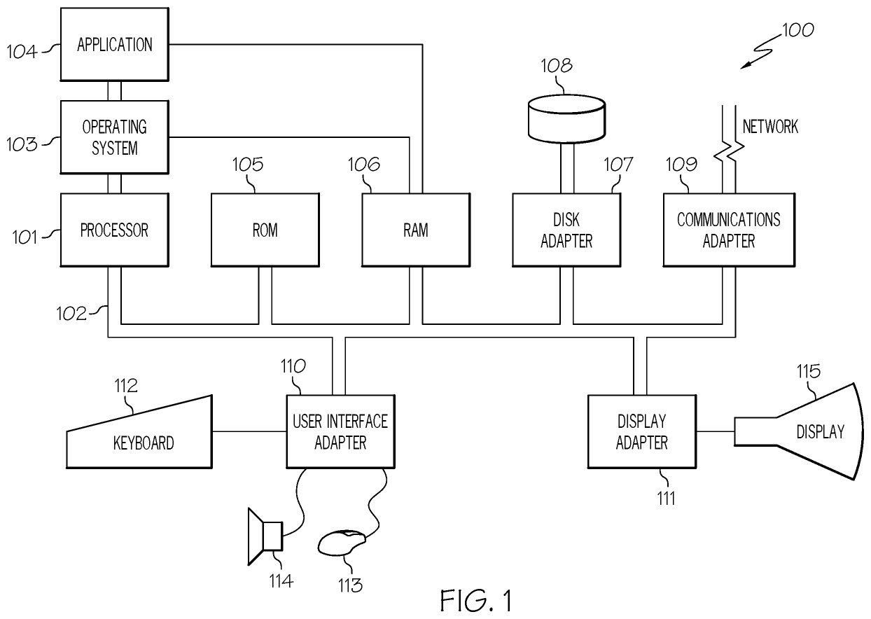

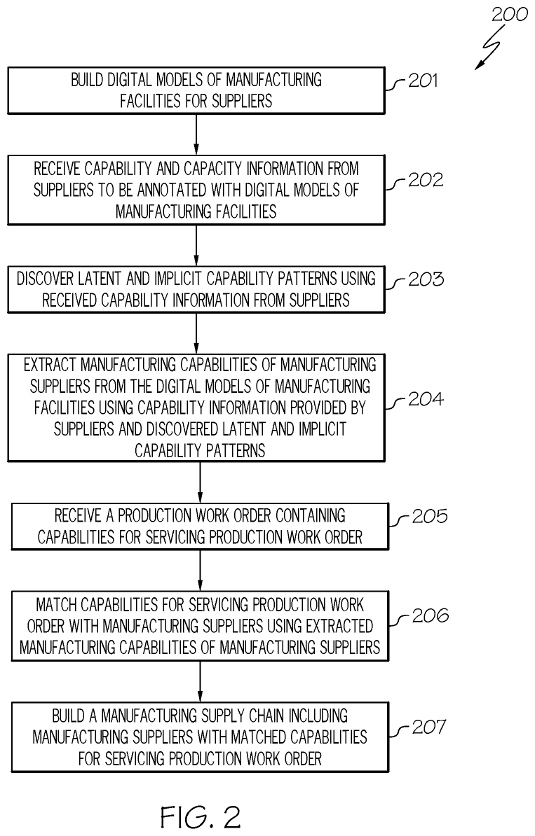

Referring now to the Figures in detail, FIG. 1 illustrates an embodiment of the present invention of the hardware configuration of a computing device 100 which is representative of a hardware environment for practicing the present invention. Computing device 100 may be any type of computing device (e.g., portable computing unit, Personal Digital Assistant (PDA), laptop computer, mobile device, tablet personal computer, smartphone, mobile phone, navigation device, gaming unit, desktop computer system, workstation, Internet appliance and the like) configured with the capability of automatically building a manufacturing supply chain for handling a production work order. Referring to FIG. 1, computing device 100 may have a processor 101 connected to various other components by system bus 102. An operating system 103 may run on processor 101 and provide control and coordinate the functions of the various components of FIG. 1. An application 104 in accordance with the principles of the present invention may run in conjunction with operating system 103 and provide calls to operating system 103 where the calls implement the various functions or services to be performed by application 104. Application 104 may include, for example, a program for automatically building a manufacturing supply chain as discussed further below in connection with FIGS. 2-13.

Referring again to FIG. 1, read-only memory (“ROM”) 105 may be connected to system bus 102 and include a basic input/output system (“BIOS”) that controls certain basic functions of computing device 100. Random access memory (“RAM”) 106 and disk adapter 107 may also be connected to system bus 102. It should be noted that software components including operating system 103 and application 104 may be loaded into RAM 106, which may be computing device's 100 main memory for execution. Disk adapter 107 may be an integrated drive electronics (“IDE”) adapter that communicates with a disk unit 108, e.g., disk drive. It is noted that the program for automatically building a manufacturing supply chain, as discussed further below in connection with FIGS. 2-13, may reside in disk unit 108 or in application 104.

Computing device 100 may further include a communications adapter 109 connected to bus 102. Communications adapter 109 may interconnect bus 102 with an outside network thereby allowing computing device 100 to communicate with other devices.

I/O devices may also be connected to computing device 100 via a user interface adapter 110 and a display adapter 111. Keyboard 112, mouse 113 and speaker 114 may all be interconnected to bus 102 through user interface adapter 110. A display monitor 115 may be connected to system bus 102 by display adapter 111. In this manner, a user is capable of inputting to computing device 100 through keyboard 112 or mouse 113 and receiving output from computing device 100 via display 115 or speaker 114. Other input mechanisms may be used to input data to computing device 100 that are not shown in FIG. 1, such as display 115 having touch-screen capability and keyboard 112 being a virtual keyboard. Computing device 100 of FIG. 1 is not to be limited in scope to the elements depicted in FIG. 1 and may include fewer or additional elements than depicted in FIG. 1.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As stated in the Background section, the manufacturing industry is undergoing profound changes brought about by the emergence of service-oriented, cloud-based, and digital manufacturing paradigms. The democratization of manufacturing is among the most visible trends that have reshaped the manufacturing landscape within the past few years. With a lowered barrier to entry, a larger number of small-to-medium sized enterprises (SMEs) are capable of offering diverse manufacturing services both internally and externally through building virtual supply networks and exploiting the resources provided by distributed partners. Consumers of manufacturing services can benefit from a larger and more diverse supply pool since they are provided with a wider range of options when searching for qualified suppliers. Nevertheless, the sheer size of the supply pool presents multiple challenges to efficiently evaluating and selecting manufacturing suppliers. Traditional approaches to manufacturing capability evaluation and supplier selection often entail direct interaction with the supplier and possibly visiting the supplier's facility to obtain better insight into the technological and organizational capabilities of the supplier. Supplier visits, accompanied by pilot production runs, will result in accurate evaluation of suppliers' capabilities but this approach is not scalable when it comes to evaluating a large group of suppliers in an agile business environment. As the interaction between suppliers and customers becomes increasingly virtual and the lifespan of supply chains becomes shorter, more efficient and intelligent approaches to capability evaluation are needed. Virtual capability analysis can be conducted through web search, online surveys, or exploring the profiles of suppliers on e-sourcing portals but they only provide rudimentary information about suppliers' capabilities. This issue is compounded by the lack of structure and formality in the way both suppliers and e-sourcing portals represent and advertise manufacturing capabilities. There are no industry standard information models for capability representation and modeling. This is major gap that needs to be filled in the digital manufacturing ecosystem.

The embodiments of the present invention provide a means for automatically building a manufacturing supply chain to service a production work order without the deficiencies discussed above, such as supplier visits, manually searching for suppliers' capabilities, etc.

FIG. 2 is a flowchart of a method 200 for automatically building a manufacturing supply chain to service a production work order in accordance with an embodiment of the present invention.

Referring to FIG. 2, in conjunction with FIG. 1, in step 201, computing device 100 builds digital models of manufacturing facilities for suppliers.

In step 202, computing device 100 receives capability and capacity information from suppliers to be annotated with the digital models of the manufacturing facilities. For example, information related to machine tools may be provided by a supplier via a user interface to computing device 100. Other examples of capability and capacity information include software capabilities, employee skills, industry capabilities, part quality capabilities, process capabilities, material capabilities, production capabilities, etc.

In step 203, computing device 100 discovers latent and implicit capability patterns using the received capability information from suppliers. For example, in one embodiment, computing device 100 utilizes natural language processing to identify keywords from the information provided by suppliers that may indicate further capabilities, such as throughput time, setup time, resolution, accuracy, speed force, power, motions, removal volumes, axes, material handling, expertise, etc. Furthermore, in one embodiment, such latent and implicit capabilities may be obtained by analyzing supplier websites or social media pages using natural language processing for identifying keywords of such latent and implicit capabilities, which may be based on the Simple Knowledge Organization System (SKOS) thesaurus of manufacturing capabilities.

In step 204, computing device 100 extracts the manufacturing capabilities of manufacturing suppliers from the digital models of the manufacturing facilities using the capability information provided by the suppliers and the discovered latent and implicit capability patterns.

In step 205, computing device 100 receives a production work order containing capabilities for servicing the production work order. For example, such a production work order may include the material capability, the process capabilities and production volume.

In step 206, computing device 100 matches the capabilities for servicing the production work order with the manufacturing suppliers using the extracted manufacturing capabilities of the manufacturing suppliers.

In step 207, computing device 100 builds a manufacturing supply chain including the manufacturing suppliers with matched capabilities for servicing the production work order.

A more detailed description of method 200 is provided below.

As discussed below, embodiments of the present invention develop a technology framework referred to herein as the “Capability Modeling for Digital Factories” (CaMDiF). As used herein, “digital factory” refers to the digital twin of a physical production facility, supplemented by the ontological representation of the facility that describes the facility in terms of installed machinery, human skills, and other production support systems and resources, including both hardware and software.

The business problem that will be solved by the developed technology solution is rapid deployment and customization of agile supply chains in virtual environments. Embodiments of the present invention significantly increase the intelligence and effectiveness of various supply chain decisions including sourcing and capability and capacity adjustment through: (1) developing an ontology for manufacturing capability representation to enable semantic interoperability and structured information exchange throughout the supply chain, where the ontology is generic and extensible enough to cover a wide spectrum of manufacturing processes; (2) provide SMEs with highly visual, user-friendly, and intuitive user interfaces for creating the digital twin of their facilities and sharing their formal capability models using the developed ontology; (3) develop the software framework for factory digitization, capability analysis, and supply chain configuration; (4) provide real-time, dynamic insight into the technological capabilities, capacities, and quality history of prospective suppliers through sharing their formal capability models; (5) automate the sourcing process by enabling active participation of software agents in sourcing decisions; and (6) improve the cyber-visibility of manufacturing companies.

In one embodiment, the CaMDiF framework and its ontology are developed based on open-source and web-native standards and protocols. The interfaces of the software framework are designed to hide the complexities of the underlying ontology. The ontology of CaMDiF is based on the Web Ontology Language (OWL). OWL is the ontology language of semantic web recommended by World Wide Web Consortium (W3C). Also, the ontology is aligned with Basic Formal Ontology (BFO) as a generic upper-level ontology. The ontology of CaMDiF is based on Manufacturing Service Description Language (MSDL). The digital factory generated using CaMDiF can be reused by third-party application due to its open syntax and semantics.

In one embodiment, since capabilities arise from resources, the inference logics of the framework are formulated such that the capability and service models of the digital factory can be inferred automatically from the available resources.

In one embodiment, the explicit and implicit capability and service models can be published using the open-source and standard ontology to be used by third-party applications for different purposes, such as supplier selection and manufacturability analysis. This can enhance the visibility of small and medium-sized manufacturers in the virtual space. Manufacturing companies can share and publish their factory service models in order to advertise their capabilities in centralized or decentralized manufacturing marketplaces and service-oriented platforms. Through exploring and querying the capability and service models of digital factories, companies can develop a deeper and more precise understanding of the technological capabilities of prospective suppliers, thus making more informed decisions when building supply chains. The benefits of the CaMDiF framework for manufacturing suppliers and OEMs are listed below.

The benefits of the CaMDiF framework for manufacturing suppliers enables manufacturing suppliers to: describe their technological capabilities in terms of manufacturing services in a machine-readable fashion using an open-source standard; describe the parts produced in the past and the qualities achieved; create a “digital twin” of their facility through selecting their installed equipment and machines from a given library of physical resources; update their capability model in real-time through updating the configuration and layout of the digital factory; locate the right customers through using the automated matching utility provided by the platform; and evaluate their technological readiness and competencies based on the current demand through using the capability scoring utility provided by the platform.

The benefits of the CaMDiF framework for OEMs enables OEMs to: evaluate the technological capabilities of prospective suppliers through capability visualization and scoring utilities; locate the right suppliers through using the automated supplier search and evaluation tool; deploy supply chains rapidly using the service composition and orchestration utility provided by the platform; and mitigate their risks through on-demand consumption of the pooled manufacturing capacities and capabilities available on the cloud.

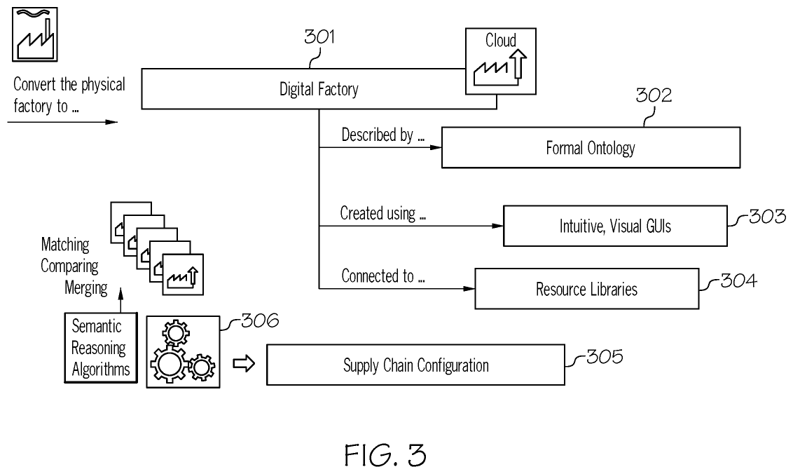

The developed technology solution (CaMDiF framework) enables users to extract the capabilities of a given manufacturing facility using intuitive and visual user interfaces. Libraries of resources (Computer Numeric Control (CNC) machines and 3D printers) provide the users with a wide range of equipment to select as shown in FIG. 3. FIG. 3 illustrates that CaMDiF enables factory digitization and supply chain configuration in accordance with an embodiment of the present invention.

Referring to FIG. 3, the physical factory is converted to a digital factory 301, which is described by a formal ontology 302, created using intuitive, visual graphical user interfaces (GUIs) 303 and connected to resource libraries 304. Furthermore, as shown in FIG. 3, CaMDiF enables supply chain configuration 305 by merging, comparing and matching those digital factories with the capabilities for servicing the production work order using semantic reasoning algorithms 306.

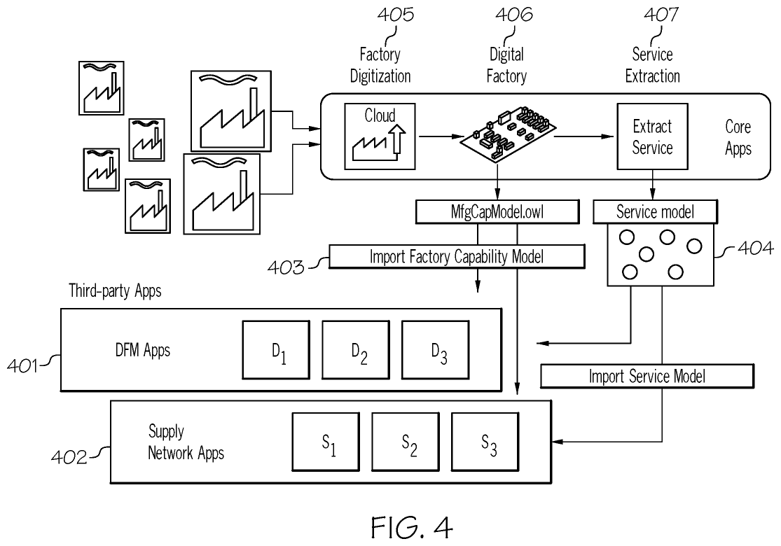

Furthermore, third-party applications can use the capability and service models created in CaMDiF for a variety of purposes, such as Design for Manufacturability (DFM) and supply chain planning as shown in FIG. 4.

FIG. 4 illustrates that 3^{rd} party applications can use the capability models generated by the CaMDiF platform in accordance with an embodiment of the present invention.

Referring to FIG. 4, third party applications, such as DFM applications 401 and supply network applications 402 use the factory capability model 403 and service model 404. In one embodiment, after factory digitization 405 to form a digital factory 406, factory capability model 403 is generated based on digital factory 406. Furthermore, as shown in FIG. 4, services are extracted 407 from digital factory 406 to form service model 404.

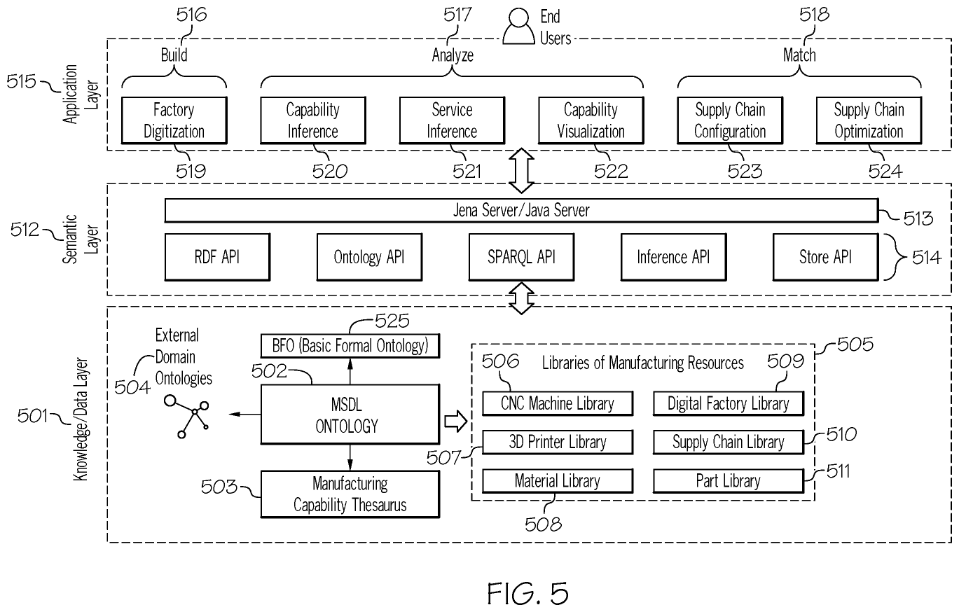

In one embodiment, the CaMDiF framework has a three-level architecture as shown in FIG. 5. FIG. 5 illustrates the software architecture of the CaMDiF framework in accordance with an embodiment of the present invention.

Referring to FIG. 5, the main components of the data and knowledge layer 501 are the MSDL ontology 502, the manufacturing capability thesaurus 503, external domain ontologies 504, and the libraries of manufacturing resources 505 including CNC machine library 506, 3D printer library 507, material library 508, digital factory library 509, supply chain library 510 and part library 511. The second layer is the semantic layer 512 which, in one embodiment, corresponds to the Apache® Jena semantic application suite which provides a set of Java libraries 513 and a set of Application Programming Interfaces (APIs) 514 (e.g., Resource Description Framework (RDF) API, Ontology API, SPARQL API, Inference API and Store API). Jena allows programmers to create, edit, and manage semantic web ontologies using RDF graphs. Also, Jena provides the necessary interfaces for query and reasoning that are usually needed in semantic applications. The last layer is the application layer 515 that has three main functions, namely, build 516, analyze 517, and match 518, which involve factory digitization 519, capability inference 520, service inference 521, capability visualization 522, supply chain configuration 523 and supply chain optimization 524 discussed further below.

Build module 516 provides a set of functions and libraries required for creating the digital twin of a manufacturing facility and inferring its capabilities. Using the factory digitization function 519 within the build module 516, manufacturing companies can interactively create the digital model of their facility and annotate it with explicit capability and capacity-related information. The interfaces hide the complexities of the underlying knowledge models used in the framework's knowledge-base. Also, simple user interfaces encourage rapid and regular update of the digital factory such that it accurately mirrors the physical facility. The digital factory is connected to a library of manufacturing resources, allowing the user to populate the factory model with the right set of resources. Any change in the digital facility will be reflected in the supplier's service and capability models in real-time.

The capability inference and service inference functions 520, 521 under the analyze module 517 are used for automatically inferring the capabilities and services associated with the digital factory. It uses the explicit capability information provided by the supplier and expands upon it through discovering latent and implicit capability patterns. The extracted manufacturing capability is represented ontologically. Capability extraction is a knowledge-intensive process that capitalizes on the domain knowledge already encoded in the ontology. Capability extraction is a bottom-up process starting with the device and machine-level capability model going up to the supply chain level. The capability extraction module can be used by third-party applications to create regional models of manufacturing capability and represent them through “capability heat maps” thanks to the rigorous capability quantification algorithms embedded in this module.

Match module 518 provides the functionalities required for matching the production work orders with the factories that have the required capabilities to fulfill the order. In the CaMDiF framework, supply and demand entities are translated into units of manufacturing service with well-defined capability expectations. Therefore, semantic matchmaking between requested services and provided services is translated into matching between requested and provided capabilities. Capability visualization 522, supply chain configuration 523 and supply chain optimization 524 functions under the match module 518 will be discussed further below.

In one embodiment, Manufacturing Service Description Language (MSDL) is used as the underlying ontology. MSDL was extended and modified to meet the needs of CaMDiF framework. MSDL was also aligned with the Basic Formal Ontology (BFO) 525 (FIG. 5) which has resulted in a significant change in the class structure of the ontology.

MSDL is a descriptive ontology, based on Web Ontology Language (OWL), that was developed for representation of capabilities of manufacturing services. MSDL decomposes the manufacturing capability into four levels of abstraction, namely, supplier-level, shop-level, machine-level, and device-level. The capabilities of every instance of the digital factory are formally described using the MSDL ontology. A unique feature of MSDL is that it is built around a service-oriented paradigm; therefore, it can be used for representing a manufacturing system as a collection of manufacturing services with specific capabilities. MSDL has a wide range of classes relevant to the CaMDiF framework, such as the classes defined below.

Manufacturing Company: A business entity involved in production of goods.

Factory: A collection of production machines and other supporting equipment used to make large quantities of goods.

Facility: The building with its facility systems together with all production equipment inside the building.

Manufacturing Capability: The abilities of a production entity related to fabricating a unit of product.

Production Capability: The abilities of a production entity related to production of large volumes of products.

Service: Intangible product that is instantly consumed as it is produced.

Manufacturing Process: A function of the production equipment that results in a change in the geometric and/or mechanical properties of the input entities.

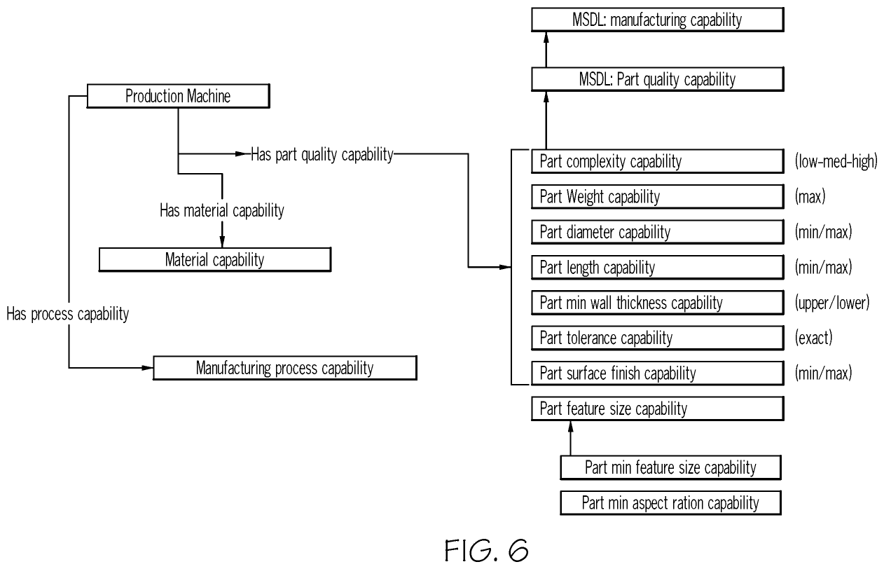

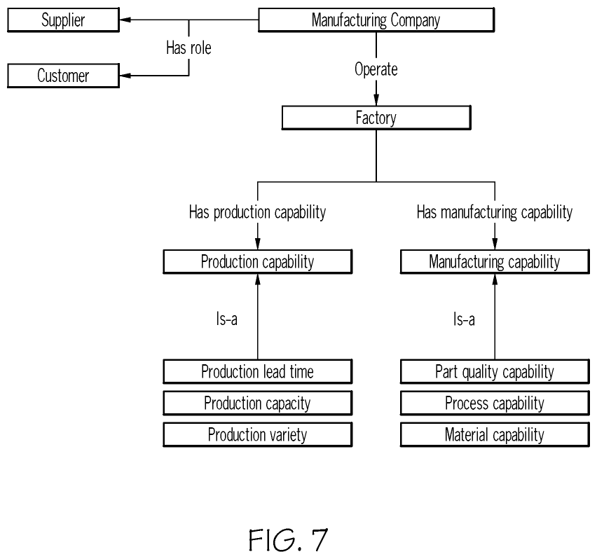

FIG. 6 illustrates the class diagram related to different types of capability for a production machine in accordance with an embodiment of the present invention. FIG. 7 illustrates different types of production and manufacturing capabilities for a typical factory in accordance with an embodiment of the present invention.

Since MSDL is designed for interoperability, it is aligned with an upper ontology so that it can be easily integrated with other manufacturing ontologies in a hub-and-spoke architecture. The modified version of MSDL that is implemented in the CaMDiF framework uses Basic Formal Ontology (BFO) as the foundational, or upper, ontology. BFO is deliberately designed to be very small and its most recent version, BFO 2.0, has 35 classes. As a domain-neutral upper-level ontology, BFO adopts a view of reality and represents different types of entities that exist in the world and relations between them. The notion of ontological realism amounts to the idea that an ontology should be analogous not to a data model, but rather to a reality model. This maximizes the utility and stability of the ontologies that are based on BFO.

BFO can be used as an integration hub for domain-specific ontologies. BFO is particularly used widely in the biomedical and biological domain. There are two types of entities in BFO, namely, continuants and occurrents. Continuants are the entities that continue to persist through time while maintaining their identity; whereas, occurrents are the events or happenings in which continuants participate. Apart from its realistic approach, BFO has multiple other unique features that make it an appropriate upper ontology for many domains. Firstly, BFO has a very large user base and it is widely used in a variety of ontologies. Secondly, BFO is very small and correspondingly easy to use and easy to learn. Additionally, BFO is very well-documented and there are multiple tutorials, guidelines, and web forums for using BFO in ontological projects.

Since, in one embodiment, MSDL is integrated with BFO, the following describes how various classes of MSDL are mapped to BFO classes.

There are three types of continuants in BFO, namely, generically dependent continuants, independent continuants, and specifically dependent continuants.

A generically dependent continuant is a continuant that is dependent on another continuant as its bearer. It can migrate from one bearer to another, such as a PDF file that can exist on multiple flash memories. An information content entity is a type of generically dependent continuant that is about another entity. For example, the measured value of the length of a shaft is a piece of information about the shaft. A measured value that is the recording of the output of a measurement process is an instance of the “measurement datum” class. Most of the generically dependent classes in MSDL are subclasses of the “measurement datum” class. Each measurement datum has a value and a unit label. Instances of the measurement datum play a pivotal role in quantifying the capabilities of manufacturing systems, including machines, machine cells, and factories.

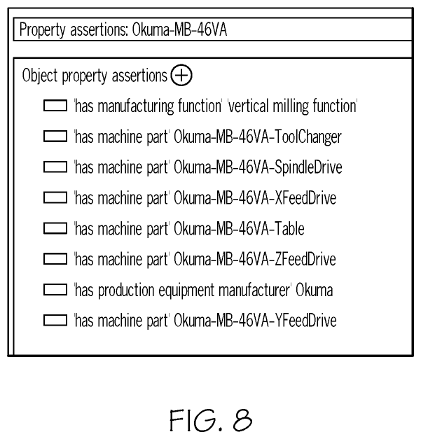

Independent continuants do not depend on other entities for their existence. For example, a machine tool or a 3D printer can exist independently as a standalone entity. The sub-categories of the independent continuant class in BFO are material entity and immaterial entity. An instance of the material entity is a continuant that includes some portion of matter. An object is a sub-class of material entity. Examples of an object in MSDL are dies, fixtures, cutting tools, workpieces, engineered artifacts, etc. Parts of production equipment, such as a machine spindle and a machine table, are also considered to be objects. A Computer Numeric Control (CNC) machine is an object aggregate in BFO since it is composed of multiple parts that are objects themselves. FIG. 8 illustrates the components of an instance of an Okuma® vertical mill in accordance with an embodiment of the present invention.

Examples of immaterial entities in MSDL include one-dimensional boundaries, such as the X-axis of a machine tool or three-dimensional sites, such as the interior of the build chamber of a 3D printer or the working envelope of a CNC vertical mill.

Specifically dependent continuants, such as color or shape, cannot migrate from one bearer to another and they depend on a specific bearer, such as this machine in this machine shop or this person in this room. Quality and realizable entity are two major subcategories of a specifically dependent continuant in BFO.

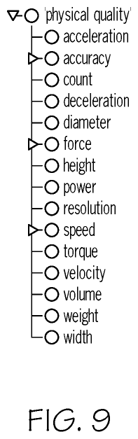

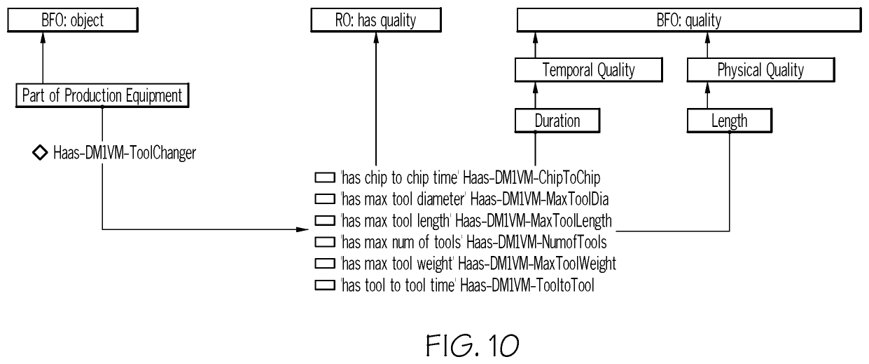

Quality is a specifically dependent continuant that is exhibited or manifested only if it is inhered in an entity. Examples of quality include the mass of a work holder, the shape of a printed part, the temperature of a machine coolant liquid, or the length of a machine table. Some of the physical qualities in MSDL are shown in FIG. 9 in accordance with an embodiment of the present invention. FIG. 10 illustrates some of the physical and temporal qualities of an instance of a tool changer system in accordance with an embodiment of the present invention. For example, the time it takes to remove a tool from a part and bring the next tool to the part (i.e., chip to chip time), is a temporal quality of the tool changer.

Realizable entities require some type of process through which they can be realized. There are two sub-categories of realizable entities in BFO, namely, function and role.

A role exists only because its bearer is in a special set of social, physical, or institutional circumstances. For example, the role of a person as a manufacturing engineer can be realized when the person is involved in a set of activities related to the manufacturing engineering profession. Also, a manufacturing company can play different roles, such as the role of a supplier or the role of a customer depending on the circumstances. Roles are externally grounded realizable entities since they are awarded to the bearer of the role by external agents. A milling machine can play the role of a backup machine for repair purpose only and this role can be assigned to the machine by the plant manager.

Functions, on the other hand, are internally grounded dispositions since their realization depends on the physical makeup of their bearer. The function of a milling machine is removing material. A milling machine can deliver this function because it is equipped with the right set of systems and tools required for removing material through the searing process. But the degree to which a milling machine can create smooth surfaces is interpreted as the capability of the milling machine and not its function. In one embodiment, capability is defined in MSDL as a subclass of BFO disposition.

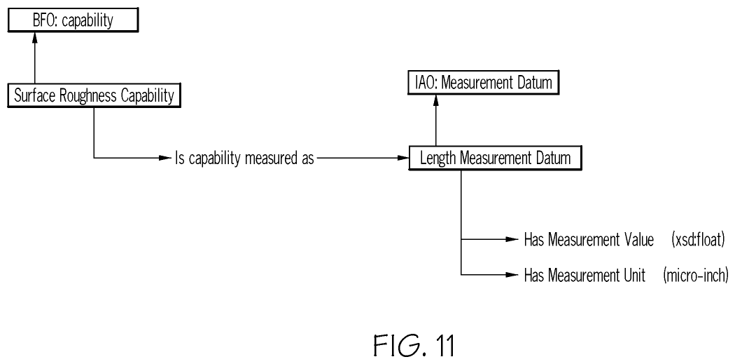

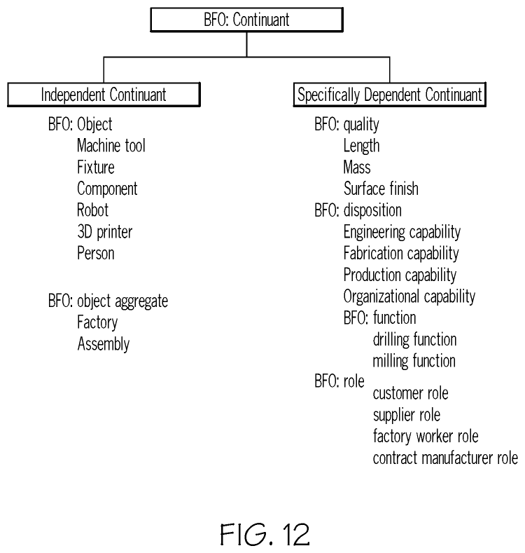

FIG. 11 illustrates the class diagram for the surface roughness capability class in MSDL in accordance with an embodiment of the present invention. As previously mentioned, capability is a measurable entity. Surface roughness is a capability measured as a length measurement datum. Two identical milling machines might have different surface finish or tolerance capabilities because they are maintained differently. Some of the MSDL continuants are shown as an example in FIG. 12 in accordance with an embodiment of the present invention.

In BFO, occurrents are the events or happenings that unfold themselves in time. Process class is one of the main subcategories of the occurrent class. Two MSDL classes that are sub-classes of BFO processes are manufacturing process and service. The manufacturing process is a process, enabled by some equipment, which alters the shape and/or properties of the input material. It should be noted that manufacturing process is different from manufacturing function since the former is an occurrent while the latter is a continuant. The function of a drilling machine has no temporal parts but a specific drilling process (or operation) should take place in a certain time interval, hence being an occurrent.

Using the capability ontology, one can create a formal representation of a factory's capability model. From the capabilities explicitly represented in the model, new capabilities can be inferred automatically using the reasoning services provided by the MSDL ontology. The approaches used for inferring manufacturing capabilities are discussed below. It should be noted that such inferences at best provide an approximation of the latent capabilities of the factory and some level of uncertainty is always assumed when inferring new capabilities. Four categories of capability are discussed below: 1) part quality capability, 2) process capability, 3) material capability, and 4) production capability.

With respect to part quality capability inference, a machine tool can create certain qualities, such as tolerance, surface roughness, or minimum feature size on a part. The range of these qualities defines the capability of the machine tool. The collective capability of the factory is calculated through aggregating the capabilities of individual machines in the factory.

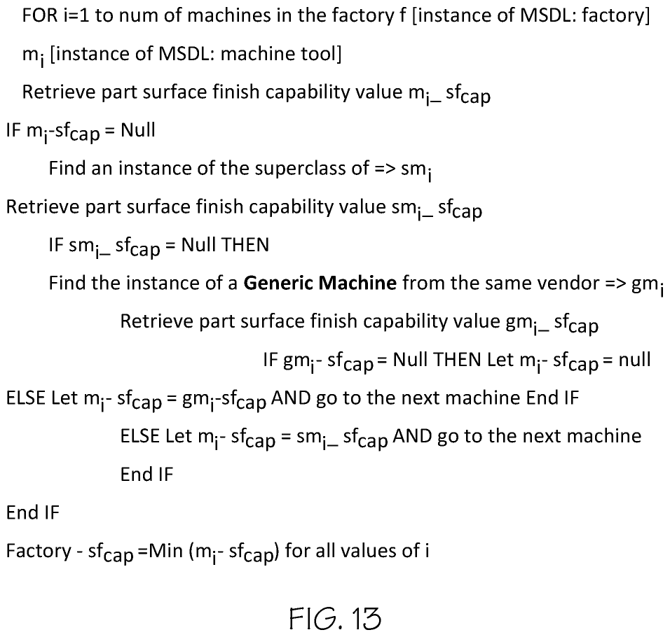

FIG. 13 illustrates the procedure for calculating the surface finish capability of a factory in accordance with an embodiment of the present invention. According to this procedure, the surface finish capability value for each factory machine, already stored as instance information, is retrieved. If the retrieved value is null, then the immediate superclass of the machine tool is queried instead and the surface finish capability value is retrieved. The reasoning behind this approach is that the parent machine can provide a reasonable approximation of the capabilities of the children machines. If none of the higher-level individuals can provide a value for surface finish capability, then a generic machine from the same machine vendor is used as the reference machine to provide some approximation about the capability of the machine. The generic machine from a given vendor is the average machine with respect to capabilities based on the vendor's product portfolio.

This procedure is based on the simplifying assumption that surface finish capability is a standalone capability. However, more realistically, surface finish capability is related to other types of capability, such as surface area capability or material capability. The ontology provides the necessary properties to build connection between different types of capabilities through relationships, such as (Cap1: is related to: Cap2), (Cap1: requires: Cap2), or (Cap1: depends on: Cap2). However, it is up to the application-level algorithms to utilize the expressivity of the ontology and estimate capabilities in a more holistic way.

Most part quality capabilities in MSDL are directly measureable. In one embodiment, the only part quality capability property that is not directly measureable is part complexity. For this purpose, the number of feed axes available on a machine is used to indirectly infer the machine's capability with respect to generating complex geometry. An ordinal scale (low, medium, high) is used for part complexity capability measurement. Accordingly, a machine that has less than three feed axes has medium to low complexity capability, while a machine with more than three axes is considered to have high complexity capability.

Material capability is also inferred based on the submission relationship between different instances of materials. The digital factory contains a list of materials that can be processed by the factory. The built-in reasoner of the CaMDiF framework can identify all super-classes of the explicitly stated material types. The instances of the identified upper level classes are then added to a list of materials that can be processed at the factory as inferred materials. The logic behind this approach is that if a vertical mill, for example, can machine a special grade of aluminum then it can also machine more generic grades of aluminum as well.

Material capability, in most real-life scenarios, is evaluated in relation with other capabilities. For example, the grade of material may impact the achievable tolerances and surface finishes on a given machine tool. These dependencies between capabilities can be encoded in the ontology through defining semantic rules.

When instances of machines are added to the factory, the manufacturing functions associated with the machines are added to the list of available processes in the factory. The functions added directly through the machines are considered to be explicit functions. The CaMDiF reasoner identifies all sub-classes of the explicit functions as the inferred functions. For example, if a machine in a factory has a “turning” function, then all instances of sub-classes of turning (including boring, facing, grooving, threading) are added to the list of “inferred” processes (functions) for that factory.

Production capability of a manufacturing facility is related to factors, such as production capacity and the variety of the products that can be produced at the facility. Simplistically, the capacity of the factory directly depends on the number of production machines available in the factory. There are some other indirect factors, such as the availability of the preventive maintenance system that can alter the capacity. In one embodiment, the capacity capability class is also measured as an ordinal measurement datum with low, medium, and high values.

The variety capability, also measured as an ordinal measurement datum, depends on the types and variety of manufacturing processes available at the factory. More processes can imply a higher variety of manufacturable parts. Therefore, the system considers both the explicit and the inferred processes when calculating the variety capability of a factory.

In one embodiment, the CaMDiF tool can operate both as a desktop application and a web-based application.

In one embodiment, depending on the use cases, different users can utilize the developed tools for different purposes. The potential users include supply chain managers at OEMs, manufacturing and design engineers at small manufacturing companies, and analysts at economic development organizations.

For example, in the OEM use case: As a supply chain engineer at an OEM, the engineer needs to quickly evaluate and compare a large number of CNC shops in central Texas in order to build a supply chain composed of up to four companies for production of a small batch that requires a quick turnaround time. The engineer can utilize the framework to evaluate the capabilities of the registered SMMs and pick the ones that closely match with the required capabilities.

In another example, in the SMM use case: As a manufacturing engineer at a small precision machining firm, the engineer can purchase the capability analysis module of the framework and conduct capability gap analysis. The engineer can compare the capabilities of a machine shop with the capabilities of similar shops in the region and use the capability recommendation function to learn about the capabilities and skills that should be acquired by the company in order to remain competitive in the next five years.

In this manner, the embodiments of the present invention are able to automatically build a manufacturing supply chain to service the production work order.

Furthermore, the present invention improves the technology or technical field involving supply chain selection. As discussed above, the manufacturing industry is undergoing profound changes brought about by the emergence of service-oriented, cloud-based, and digital manufacturing paradigms. The democratization of manufacturing is among the most visible trends that have reshaped the manufacturing landscape within the past few years. With a lowered barrier to entry, a larger number of small-to-medium sized enterprises (SMEs) are capable of offering diverse manufacturing services both internally and externally through building virtual supply networks and exploiting the resources provided by distributed partners. Consumers of manufacturing services can benefit from a larger and more diverse supply pool since they are provided with a wider range of options when searching for qualified suppliers. Nevertheless, the sheer size of the supply pool presents multiple challenges to efficiently evaluating and selecting manufacturing suppliers. Traditional approaches to manufacturing capability evaluation and supplier selection often entail direct interaction with the supplier and possibly visiting the supplier's facility to obtain better insight into the technological and organizational capabilities of the supplier. Supplier visits, accompanied by pilot production runs, will result in accurate evaluation of suppliers' capabilities but this approach is not scalable when it comes to evaluating a large group of suppliers in an agile business environment. As the interaction between suppliers and customers becomes increasingly virtual and the lifespan of supply chains becomes shorter, more efficient and intelligent approaches to capability evaluation are needed. Virtual capability analysis can be conducted through web search, online surveys, or exploring the profiles of suppliers on e-sourcing portals but they only provide rudimentary information about suppliers' capabilities. This issue is compounded by the lack of structure and formality in the way both suppliers and e-sourcing portals represent and advertise manufacturing capabilities. There are no industry standard information models for capability representation and modeling. This is major gap that needs to be filled in the digital manufacturing ecosystem.

The present invention improves such technology by automatically building a manufacturing supply chain to service a production work order without the deficiencies discussed above, such as supplier visits, manually searching for suppliers' capabilities, etc. For example, the present invention allows supply chain specialists in large OEMs and medium-sized companies to evaluate their prospective suppliers and quickly compare different supply chain alternatives. Supplier companies (suppliers) can also use the software tool of the present invention for capability self-assessment. In this manner, there is an improvement in the technical field of supply chain selection.

The technical solution provided by the present invention cannot be performed in the human mind or by a human using a pen and paper. That is, the technical solution provided by the present invention could not be accomplished in the human mind or by a human using a pen and paper in any reasonable amount of time and with any reasonable expectation of accuracy without the use of a computer.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for automatically building a manufacturing supply chain, the method comprising:
building digital models of manufacturing facilities for suppliers;
receiving capability and capacity information from said suppliers to be annotated with said digital models of said manufacturing facilities;
discovering latent and implicit capability patterns using said received capability information from said suppliers;
extracting manufacturing capabilities of manufacturing suppliers from said digital models of said manufacturing facilities using said capability information provided by said suppliers and said discovered latent and implicit capability patterns;
receiving a production work order containing capabilities for servicing said production work order, wherein said capabilities in said production work order comprise one or more of the following: material capability, process capabilities and production volume;
matching capabilities for servicing said production work order with manufacturing suppliers using said extracted manufacturing capabilities of manufacturing suppliers; and
building a manufacturing supply chain comprising said manufacturing suppliers with matched capabilities for servicing said production work order.

2. The method as recited in claim 1 further comprising:
populating said digital models of said manufacturing facilities with resources from a library of manufacturing resources.

3. The method as recited in claim 1, wherein said extracted manufacturing capabilities are represented ontologically.

4. The method as recited in claim 1, wherein said discovered latent and implicit capability patterns comprise part quality capability, process capability, material capability and production capability.

5. The method as recited in claim 1 further comprising:
analyzing a single manufacturing supplier to determine capabilities of said single manufacturing supplier comprising one or more of the following: part quality capability, process capability, material capability and production capability.

6. The method as recited in claim 1 further comprising:
comparing a first manufacturing supplier with a second manufacturing supplier in terms of capabilities comprising one or more of the following: part quality capability, process capability, material capability and production capability.

7. A computer program product for automatically building a manufacturing supply chain, the computer program product comprising one or more computer readable storage mediums having program code embodied therewith, the program code comprising the programming instructions for:
building digital models of manufacturing facilities for suppliers;
receiving capability and capacity information from said suppliers to be annotated with said digital models of said manufacturing facilities;
discovering latent and implicit capability patterns using said received capability information from said suppliers;
extracting manufacturing capabilities of manufacturing suppliers from said digital models of said manufacturing facilities using said capability information provided by said suppliers and said discovered latent and implicit capability patterns;
receiving a production work order containing capabilities for servicing said production work order, wherein said capabilities in said production work order comprise one or more of the following: material capability, process capabilities and production volume;
matching capabilities for servicing said production work order with manufacturing suppliers using said extracted manufacturing capabilities of manufacturing suppliers; and
building a manufacturing supply chain comprising said manufacturing suppliers with matched capabilities for servicing said production work order.

8. The computer program product as recited in claim 7, wherein the program code further comprises the programming instructions for:
populating said digital models of said manufacturing facilities with resources from a library of manufacturing resources.

9. The computer program product as recited in claim 7, wherein said extracted manufacturing capabilities are represented ontologically.

10. The computer program product as recited in claim 7, wherein said discovered latent and implicit capability patterns comprise part quality capability, process capability, material capability and production capability.

11. The computer program product as recited in claim 7, wherein the program code further comprises the programming instructions for:
analyzing a single manufacturing supplier to determine capabilities of said single manufacturing supplier comprising one or more of the following: part quality capability, process capability, material capability and production capability.

12. The computer program product as recited in claim 7, wherein the program code further comprises the programming instructions for:
comparing a first manufacturing supplier with a second manufacturing supplier in terms of capabilities comprising one or more of the following: part quality capability, process capability, material capability and production capability.

13. A system, comprising:
a memory for storing a computer program for automatically building a manufacturing supply chain; and
a processor connected to the memory, wherein the processor is configured to execute the program instructions of the computer program comprising:
building digital models of manufacturing facilities for suppliers;
receiving capability and capacity information from said suppliers to be annotated with said digital models of said manufacturing facilities;
discovering latent and implicit capability patterns using said received capability information from said suppliers;
extracting manufacturing capabilities of manufacturing suppliers from said digital models of said manufacturing facilities using said capability information provided by said suppliers and said discovered latent and implicit capability patterns;
receiving a production work order containing capabilities for servicing said production work order, wherein said capabilities in said production work order comprise one or more of the following: material capability, process capabilities and production volume;
matching capabilities for servicing said production work order with manufacturing suppliers using said extracted manufacturing capabilities of manufacturing suppliers; and
building a manufacturing supply chain comprising said manufacturing suppliers with matched capabilities for servicing said production work order.

14. The system as recited in claim 13, wherein the program instructions of the computer program further comprise:
populating said digital models of said manufacturing facilities with resources from a library of manufacturing resources.

15. The system as recited in claim 13, wherein said extracted manufacturing capabilities are represented ontologically.

16. The system as recited in claim 13, wherein said discovered latent and implicit capability patterns comprise part quality capability, process capability, material capability and production capability.

17. The system as recited in claim 13, wherein the program instructions of the computer program further comprise:
analyzing a single manufacturing supplier to determine capabilities of said single manufacturing supplier comprising one or more of the following: part quality capability, process capability, material capability and production capability.

18. The system as recited in claim 13, wherein the program instructions of the computer program further comprise:
comparing a first manufacturing supplier with a second manufacturing supplier in terms of capabilities comprising one or more of the following: part quality capability, process capability, material capability and production capability.
